(19) United States
(12) Patent Application Publication
(10) Pub. No.: US 2026/0155295 A1
(43) Pub. Date: Jun. 4, 2026

(54) MAGNETIC COMPONENT

(71) Applicant: Delta Electronics, Inc., Taoyuan City (TW)

(72) Inventors: Saisai Ni, Shanghai (CN); Xiaoqiang Yu, Shanghai (CN); Haijun Yang, Shanghai (CN)

(21) Appl. No.: 19/399,288

(22) Filed: Nov. 24, 2025

(30) Foreign Application Priority Data
Dec. 4, 2024 (CN) 202411773453.8

(51) Int. Cl. H01F 27/30; H01F 27/24; H01F 27/28; H01F 27/29

(52) U.S. Cl. CPC H01F 27/30; H01F 27/24; H01F 27/2847; H01F 27/29

(57) ABSTRACT

A magnetic component is disclosed and includes a first magnetic core, a second magnetic core and a coil. The first magnetic core includes a first magnetic cover and a first guiding portion. The second magnetic core includes a second magnetic cover and a second guiding portion. The first magnetic core and the second magnetic core are butted along an axial direction to form a winding column. The first guiding portion is located on the first magnetic cover, and increases a depth embedded into the first magnetic cover. The second guiding portion is located on the second magnetic cover, and increases a depth embedded into the second magnetic cover. The coil is wound on the winding column at a helical angle α relative to the winding column, and includes a first outlet terminal and a second outlet terminal led out along the first guiding portion and the second guiding portion, respectively.

### CROSS-REFERENCE TO RELATED APPLICATION

This application claims priority to China Patent Application No. 202411773453.8, filed on Dec. 4, 2024. The entire contents of the above-mentioned patent application are incorporated herein by reference for all purposes.

### FIELD OF THE INVENTION

The present disclosure relates to an assembling structure for electronic components, and more particularly to a magnetic component with an improved structure.

### BACKGROUND OF THE INVENTION

As the functions and the performance of electronic equipment increase, each electronic component inside the power supply needs to handle more and more power. Especially in the high power density applications, the size of the magnetic components should be minimized. Moreover, the magnetic components are required to have a certain overload capacity. This places higher demands on the heat dissipation and anti-saturation of magnetic components. At the same time, in order to meet the opportunities and challenges of Industry 4.0 and Smart Manufacturing 2035, digitization and automation will be further integrated. That is, with the investment in industrial robots and automation equipment, the magnetic components need to be automatically produced. This also places higher requirements on the assembly of magnetic components.

For the magnetic component, when the cross-sectional area of the magnetic core is constant under the same inductance and working conditions, the more turns the coil has, the greater the anti-saturation capability of the coil will be. However, as the number of turns increases, coil loss also increases, thereby making it more difficult to dissipate heat. Especially in low-voltage and high-current working conditions, it is necessary to use large-diameter wires for withstanding the large current. The wires need to be wound along the axial direction of the winding column in a spiral rising structure, and it results in different heights in the coil. When assembling the coil with the magnetic core, the height of the magnetic core window needs to be configured based on the maximum height of the coil with a certain margin (such as 0.2 mm). As a result, some space is wasted.

For the coil, the larger the size of the wire along the axial direction, the greater the height difference produced after each spiral rises. After the coil and magnetic core are assembled, the more space is wasted and the degree of distortion becomes more serious. Moreover, it is more difficult to achieve automated assembly with the magnetic core.

On the other hand, for the core structure of low-voltage and high-current magnetic components, the magnetic core usually has a magnetic core window with equal heights everywhere. The coil can be made of tinned copper sheet or enameled copper wire (round or flat). In case the tinned copper sheets are used to produce the coil, the formation of the coil is relatively simple, but it has to use a stamping forming (and then tin plating) process, so that a lot of consumables are required. Moreover, physical isolation such as air distance or insulating tape is required for insulation between coil turns, so that the height of the coil is increased and it results in a larger inductor size. In case the enameled copper wire (round or flat) is used to produce the coil, there will be an enameled layer for insulation between the turns of the coil and between the coil and the magnetic core. However, since the wire is wound along the axis of the winding column in a spiral rising structure, the heights at the beginning and end of the coil are different. Moreover, the height of the magnetic core window is higher than the maximum height of the coil. As a result, the size of the magnetic core is larger and the power density is difficult to increase. When the number of turns (>=2) is smaller, the proportion of line width to the total height of the coil is larger. This problem will become more serious.

In view of this, there is a need to provide a magnetic component with an improved structure, so as to reduce the waste of coil space, improve the power density, and obviate the drawbacks encountered by the prior arts.

### SUMMARY OF THE INVENTION

An object of the present disclosure is to provide a magnetic component with an improved structure. The magnetic core has an improved structure (such as a spiral groove, a slope-shaped groove or a stepped groove) at the coil outlet position, so as to ensure that the outlet position does not affect the configuration of the magnetic core, and further realize that the height of the magnetic core does not need to be designed according to the maximum coil size. When the magnetic component has the overload requirements, the number of coil turns can be appropriately increased to enhance the anti-saturation capability of the magnetic component and at the same time increase the power density of the magnetic component. Since the groove structure and the shape of the coil are basically matched with each other, the coil is not prone to skewing during assembly. It also helps to meet the automated production requirements, improve the quality and reduce the costs.

Another object of the present disclosure is to provide a magnetic component with an improved structure. By processing the inner wall of the magnetic core into a structure of a spiral groove, a slope-shaped groove or a stepped groove, the height of the magnetic core window occupied by the coil outlet is reduced and the utilization rate of the magnetic core window is improved, so that the purposes of increasing the number of coil turns, increasing the cross-sectional area of the wires or reducing the height and the size of the winding column are achieved. It also improves the matching between the magnetic core and the coil, and helps to realize the efficient and automated assembly of the coil and the magnetic core.

In accordance with an aspect of the present disclosure, a magnetic component is provided and includes a first magnetic core, a second magnetic core and a coil. The first magnetic core includes a first magnetic cover and a first guiding portion. The second magnetic core includes a second magnetic cover and a second guiding portion, wherein the first magnetic core and the second magnetic core are butted along an axial direction to form a winding column, wherein the winding column has a first end and a second end oppositely arranged along the axial direction, the first magnetic cover is located at the first end, and the second magnetic cover is located at the second end, wherein the first guiding portion is disposed adjacent to the first end and located on the first magnetic cover, and increases a depth embedded into the first magnetic cover along a direction from the second magnetic cover facing the first magnetic cover, wherein the second guiding portion is disposed adjacent to the second end and located on the second magnetic cover, and increases a depth embedded into the second magnetic cover along a direction from the first magnetic cover facing the second magnetic cover. The coil is wound on the winding column at a helical angle α relative to the winding column, and includes a first outlet terminal and a second outlet terminal, wherein the first outlet terminal is led out along the first guiding portion, and the second outlet terminal is led out along the second guiding portion.

The beneficial effect of the present disclosure is that the embodiments of the present disclosure provide a magnetic component with an improved structure. The magnetic core has an improved structure (such as a spiral groove, a slope-shaped groove or a stepped groove) at the coil outlet position, so as to reduce the height of the magnetic core window occupied by the coil outlet, improve the utilization rate of the magnetic core window, and achieve the purposes of increasing the number of coil turns, increasing the cross-sectional area of the wires or reducing the height and the size of the winding column. At the same time, it ensures that the outlet position does not affect the configuration of the magnetic core, and further realize that the height of the magnetic core does not need to be designed according to the maximum coil size. When the magnetic component has the overload requirements, the number of coil turns can be appropriately increased to enhance the anti-saturation capability of the magnetic component and increase the power density of the magnetic component at the same time. Since the shape of the coil is matched with the groove structure, the coil is not prone to skewing during assembly, and it helps to meet the automated production requirements, improve the quality and reduce the costs.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a structural perspective view illustrating a magnetic component according to a first embodiment of the present disclosure;

FIG. 2 is a top view illustrating the magnetic component according to the first embodiment of the present disclosure;

FIG. 3 is an exploded structural view illustrating the magnetic component according to the first embodiment of the present from the top perspective;

FIG. 4 is an exploded structural view illustrating a magnetic component according to a second embodiment of the present disclosure from the top perspective;

FIG. 5 is an exploded structural view illustrating the magnetic component according to the second embodiment of the present disclosure from the lateral perspective;

FIG. 6 is an exploded structural view illustrating a magnetic component according to a third embodiment of the present disclosure from the top perspective;

FIG. 7 is an exploded structural view illustrating the magnetic component according to the third embodiment of the present disclosure from the lateral perspective;

FIG. 8 is a structural perspective view illustrating a magnetic component according to a fourth embodiment of the present disclosure;

FIG. 9 is an exploded structural view illustrating the magnetic component according to the fourth embodiment of the present disclosure;

FIG. 10 is a structural perspective view illustrating a magnetic component according to a fifth embodiment of the present disclosure;

FIG. 11 is an exploded structure view illustrating the magnetic component according to the fifth embodiment of the present disclosure;

FIG. 12 is a top view illustrating the flat wire coil flatly wound on the rounded rectangular winding column;

FIG. 13A and FIG. 13B are schematic views illustrating the flat wire coil flatly wound on the rounded rectangular winding column in view of the axial direction;

FIG. 14 is a structural perspective view illustrating a magnetic component according to a sixth embodiment of the present disclosure;

FIG. 15 is an exploded structural view illustrating the magnetic component according to the sixth embodiment of the present disclosure;

FIG. 16 is a structural perspective view illustrating a magnetic component according to a seventh embodiment of the present disclosure;

FIG. 17 is an exploded structural view illustrating the magnetic component according to the seventh embodiment of the present disclosure;

FIG. 18 is a structural perspective view illustrating a magnetic component according to an eighth embodiment of the present disclosure;

FIG. 19 is an exploded structural view illustrating the magnetic component according to the eighth embodiment of the present disclosure;

FIG. 20 is a structural perspective view illustrating the first magnetic core of the magnetic component according to the eighth embodiment of the present disclosure;

FIG. 21 is a schematic diagram illustrating the coil wound on the magnetic core of the magnetic component according to the eighth embodiment of the present disclosure in view of the axial direction;

FIG. 22 is a schematic diagram illustrating the coil wound on the magnetic core of the magnetic component according to the eighth embodiment of the present disclosure from the top perspective;

FIG. 23 is a structural perspective view illustrating a magnetic component according to a ninth embodiment of the present disclosure;

FIG. 24 is a schematic diagram of illustrating the coil wound on the magnetic core of the magnetic component according to the ninth embodiment of the present disclosure from the top perspective;

FIG. 25 is a structural lateral view illustrating the first magnetic core and the second magnetic core of the magnetic component according to the ninth embodiment of the present disclosure; and

FIG. 26A and FIG. 26B are schematic views illustrating the coil of the magnetic component according to the ninth embodiment of the present disclosure in view of the axial direction.

### DETAILED DESCRIPTION

The present disclosure will now be described more specifically with reference to the following embodiments. It is to be noted that the following descriptions of embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed. Further, spatially relative terms, such as “upper,” “lower,” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

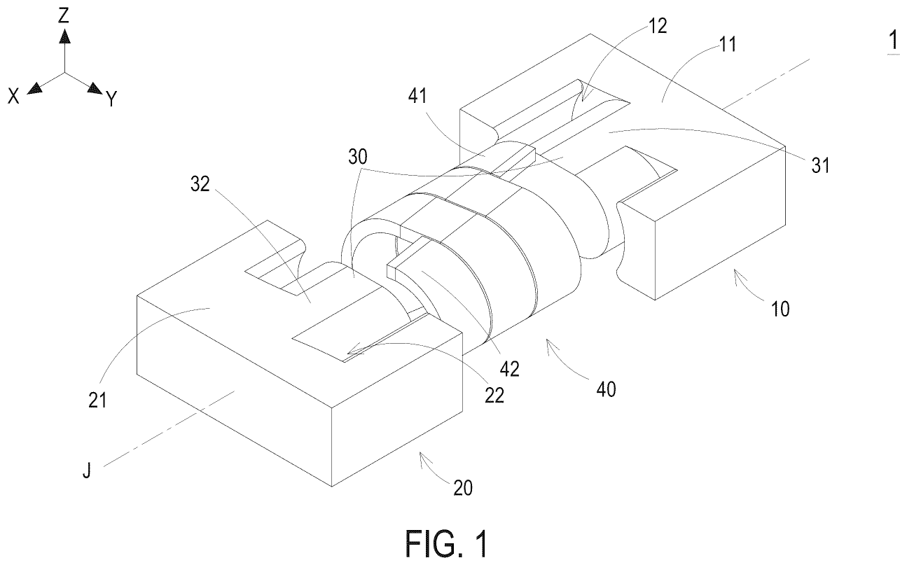

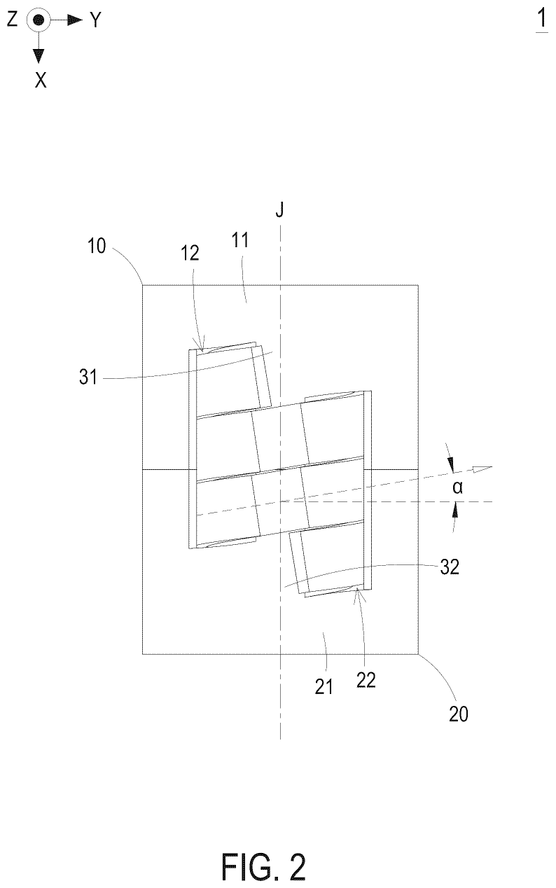

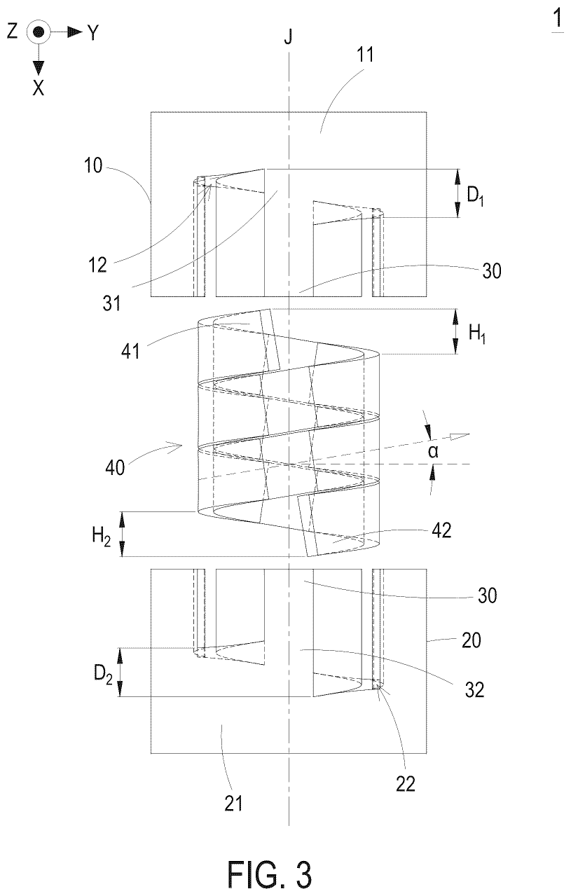

FIG. 1 is a structural perspective view illustrating a magnetic component according to a first embodiment of the present disclosure. FIG. 2 is a top view illustrating the magnetic component according to the first embodiment of the present disclosure. FIG. 3 is an exploded structural view illustrating the magnetic component according to the first embodiment of the present from the top perspective. In the embodiment, the present disclosure provides a magnetic component 1, which is suitable for a low-voltage and high-current conventional inductors, a matrix inductor, a coupled inductor, a conventional transformer or a matrix transformer. The magnetic component 1 includes a first magnetic core 10, a second magnetic core 20 and a coil 40. The first magnetic core 10 includes a first magnetic cover 11 and a first guiding portion 12. The second magnetic core 20 includes a second magnetic cover 21 and a second guiding portion 22. In the embodiment, the first magnetic core 10 and the second magnetic core 20 are butted along an axial direction J to form a winding column 30. In the embodiment, the winding column 30 has a first end 31 and a second end 32 oppositely arranged along the axial direction J. The first magnetic cover 11 is located at the first end 31, and the second magnetic cover 21 is located at the second end 32. The first guiding portion 12 is disposed adjacent to the first end 31 and located on the first magnetic cover 11, and increases a depth embedded into the first magnetic cover 11 along a direction from the second magnetic cover 21 facing the first magnetic cover 11. In addition, the second guiding portion 22 is disposed adjacent to the second end 32 and located on the second magnetic cover 21, and increases a depth embedded into the second magnetic cover 21 along a direction from the first magnetic cover 11 facing the second magnetic cover 21. The coil 40 is wound on the winding column 30 at a helical angle α relative to the winding column 30, and includes a first outlet terminal 41 and a second outlet terminal 42. In the embodiment, the first outlet terminal 41 is led out along the first guiding portion 12, and the second outlet terminal 42 is led out along the second guiding portion 22.

In the embodiment, a cross section of the winding column 30 perpendicular to the axial direction J is racetrack-shaped. In other embodiment, the cross section of the winding column 30 perpendicular to the axial direction J is circular or rounded rectangular. In the embodiment, the coil 40 includes a flat wire. In other embodiments, the coil 40 includes a round wire. In the embodiment, the first guiding portion 12 and the second guiding portion 22 are spiral grooves. Moreover, shapes of the first guiding portion 12 and the second guiding portion 22 are matched with shapes of the first outlet terminal 41 and the second outlet terminal 42, respectively. In the embodiment, the first guiding portion 12 increases by a first depth D₁ along the direction (i.e., the negative direction of the X axis) from the second magnetic cover 21 facing the first magnetic cover 11, and the second guiding portion 22 increases by a second depth D₂ along the direction (i.e., the positive direction of the X axis) from the first magnetic cover 11 facing the second magnetic cover 21. In some embodiments, the first depth D₁ and the second depth D₂ are equal to each other. In some embodiments of the present disclosure, the first depth D₁ of the first guiding portion 12 along the axial direction J is greater than a first extending width H₁ of the first outlet terminal 41, and the second depth D₂ of the second guiding portion 22 along the axial direction J is greater than a second extending width H₂ of the second outlet terminal 42. It should be noted that in the present disclosure, the inner walls of the first magnetic core 10 and the second magnetic core 20 are processed to form the first guiding portion 12 and the second guiding portion 22, which are consistent with the spiral trajectory of the first outlet terminal 41 and the second outlet terminal 42 of the coil 40. It improves the matching between of the first magnetic core 10, the second magnetic core 20 and the coil 40, and helps to realize the efficient and automated assembly of the coil and the magnetic core. Furthermore, the led-out positions of the coil 40 in the first magnetic core 10 and the second magnetic core 20 are improved through the first guiding portion 12 and the second guiding portion 22, and it helps to reduce the height of the magnetic core window occupied by the coil outlet, improve the utilization rate of the magnetic core window, and achieve the purposes of increasing the number of coil turns, increasing the cross-sectional area of the wires or reducing the height and the size of the winding column. At the same time, it ensures that the outlet position of the coil 40 does not affect the configuration of the first magnetic core 10 and the second magnetic core 20, and further realize that the height of the magnetic core does not need to be designed according to the maximum coil size. When the magnetic component 1 has the overload requirements, the number of coil turns can be appropriately increased to enhance the anti-saturation capability of the magnetic component and increase the power density of the magnetic component at the same time.

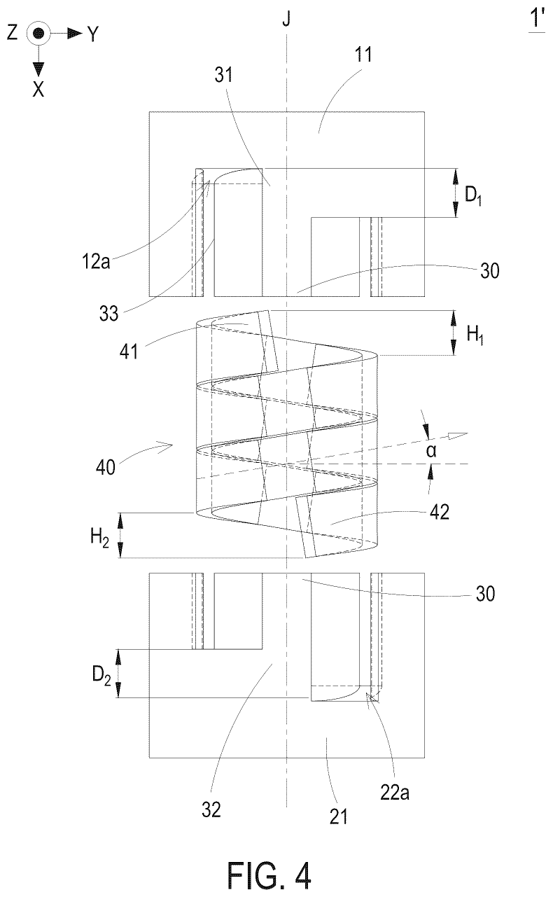

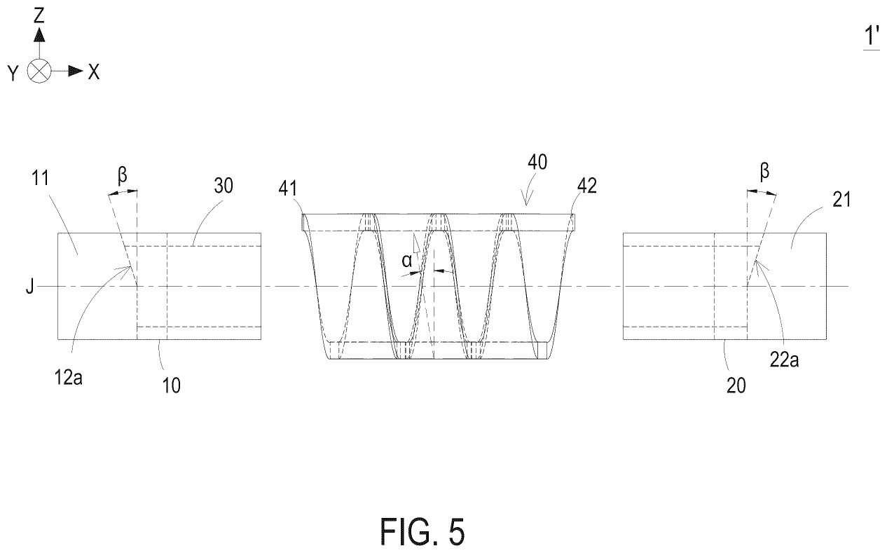

FIG. 4 is an exploded structural view illustrating a magnetic component according to a second embodiment of the present disclosure from the top perspective. FIG. 5 is an exploded structural view illustrating the magnetic component according to the second embodiment of the present disclosure from the lateral perspective. In the embodiment, the structures, elements and functions of the magnetic component 1′ are similar to those of the magnetic component 1 of FIG. 1 to FIG. 3, and are not redundantly described herein. In the embodiment, the first guiding portion 12a forms a first slope-shaped groove along the first outlet terminal 41 toward a side away from the first outlet terminal 41, and the second guiding portion 22a forms a second slope-shaped groove along the second outlet terminal 42 toward a side away from the second outlet terminal 42. Specifically, taking the second guiding portion 22a shown in FIG. 4 as an example, the second guiding portion 22a gets closer and closer to the edge of the second magnetic cover 21 facing the paper surface downward along the axial direction J, thereby forming a slope shape. In the embodiment, the first guiding portion 12a and the second guiding portion 22a have an inclination angle β greater than the helical angle α of the first outlet terminal 41 and the second outlet terminal 42. Along the axial direction J, the first depth D₁ of the first slope-shaped groove of the first guiding portion 12a is greater than the first extending width H₁ of the first outlet terminal 41, and the second depth D₂ of the second slope-shaped groove of the second guiding portion 22a is greater than the second extending width H₂ of the second outlet terminal. Since the led-out positions of the coil 40 in the first magnetic core 10 and the second magnetic core 20 are improved through the first guiding portion 12a and the second guiding portion 22a, it helps to reduce the height of the magnetic core window occupied by the coil outlet, improve the utilization rate of the magnetic core window, and further achieve the purposes of increasing the number of coil turns, increasing the cross-sectional area of the wires or reducing the height and the size of the winding column.

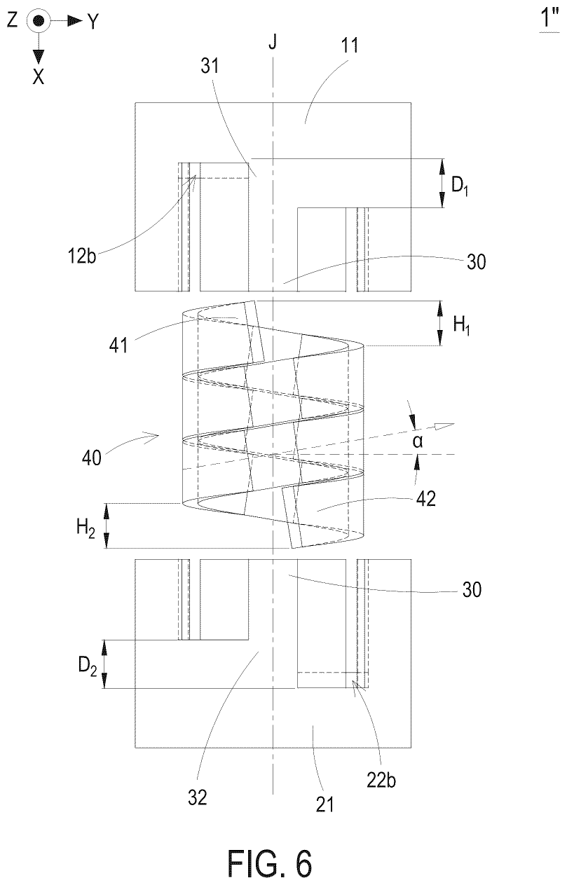

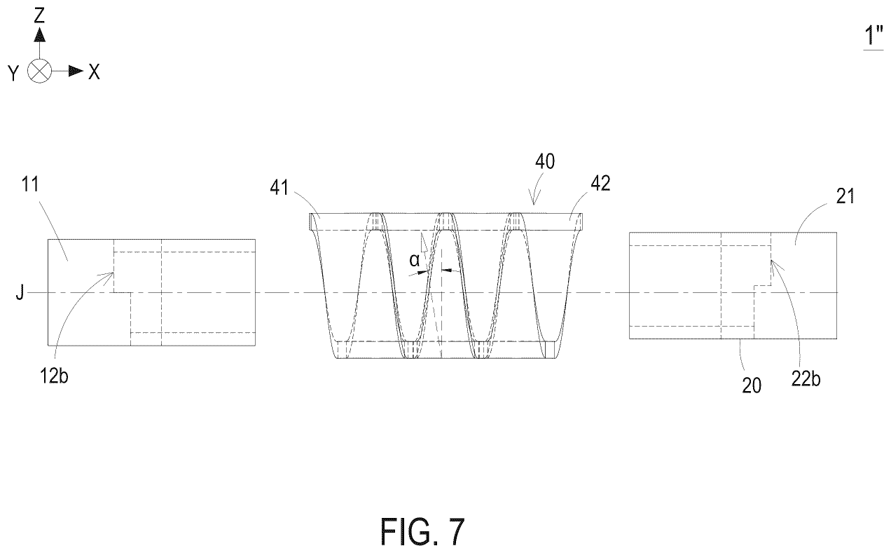

FIG. 6 is an exploded structural view illustrating a magnetic component according to a third embodiment of the present disclosure from the top perspective. FIG. 7 is an exploded structural view illustrating the magnetic component according to the third embodiment of the present disclosure from the lateral perspective. In the embodiment, the structures, elements and functions of the magnetic component 1″ are similar to those of the magnetic component 1 of FIG. 1 to FIG. 3, and are not redundantly described herein. In the embodiment, the first guiding portion 12b forms a first stepped groove along the first outlet terminal 41 toward a side away from the first outlet terminal 41, and the second guiding portion 22b forms a second stepped groove along the second outlet terminal 42 toward a side away from the second outlet terminal 42. Specifically, taking the second guiding portion 22b shown in FIG. 6 as an example, there is a height difference between the bottom surface of the second stepped groove and the surface of the magnetic cover contacting the winding column 30, thereby forming a stepped structure. Furthermore, along the axial direction J, the first depth D₁ of the first stepped groove of the first guiding portion 12b is greater than the first extending width H₁ of the first outlet terminal 41, and the second depth D₂ of the second stepped groove of the second guiding portion 22b is greater than the second extending width H₂ of the second outlet terminal 42. Since the led-out positions of the coil 40 in the first magnetic core 10 and the second magnetic core 20 are improved through the first guiding portion 12b and the second guiding portion 22b, it helps to reduce the height of the magnetic core window occupied by the coil outlet, improve the utilization rate of the magnetic core window, and further achieve the purposes of increasing the number of coil turns, increasing the cross-sectional area of the wires or reducing the height and the size of the winding column.

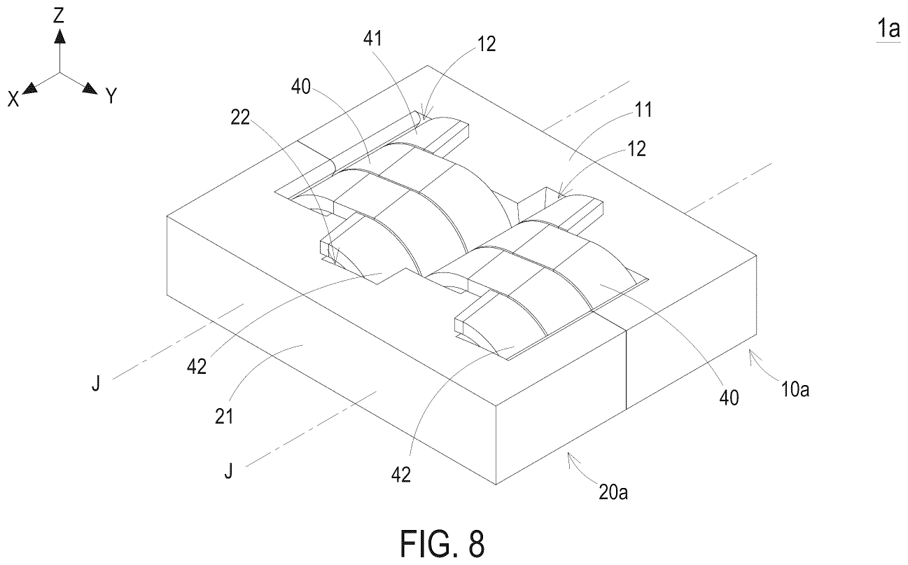

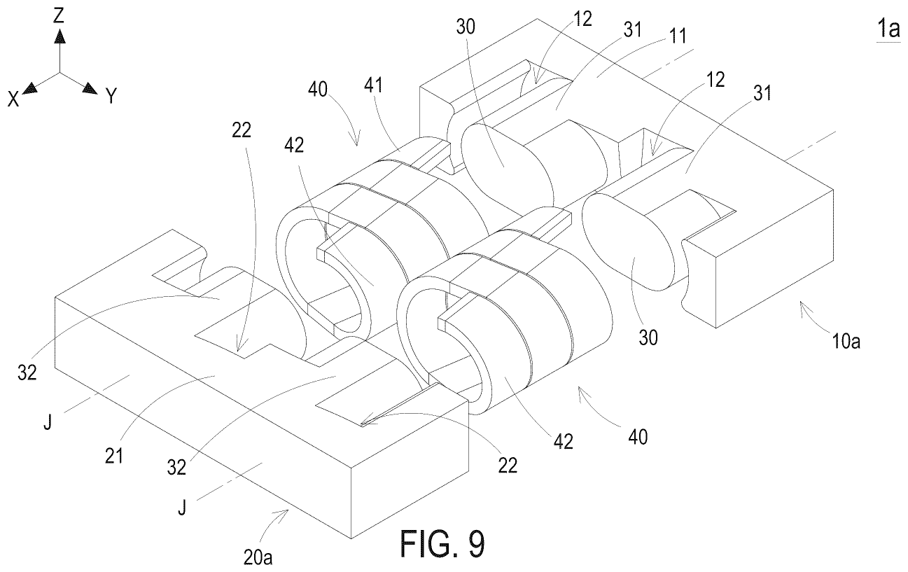

FIG. 8 is a structural perspective view illustrating a magnetic component according to a fourth embodiment of the present disclosure. FIG. 9 is an exploded structural view illustrating the magnetic component according to the fourth embodiment of the present disclosure. In the embodiment, the structures, elements and functions of the magnetic component 1a are similar to those of the magnetic component 1 of FIG. 1 to FIG. 3, and are not redundantly described herein. In the embodiment, the magnetic component 1a includes a first magnetic core 10a, a second magnetic core 20a and two coils 40. The first magnetic core 10a includes a first magnetic cover 11 and two first guiding portions 12. The second magnetic core 20a includes a second magnetic cover 21 and two second guiding portions 22. The first magnetic core 10a and the second magnetic core 20a are butted along the axial direction J to form two winding columns 30. The two winding columns 30 are arranged in parallel along a direction (such as the Y axial direction) perpendicular to the axial direction J. The two coils 40 are wound on the two winding columns 30, respectively. Thereby, the matching between the magnetic core and the coil 40 in the magnetic component 1a is improved, it allows expanding along the specific direction (i.e., the Y axial direction) perpendicular to the axial direction J, and realizing the efficient and automated assembly of the coil 40 and the magnetic core at the same time.

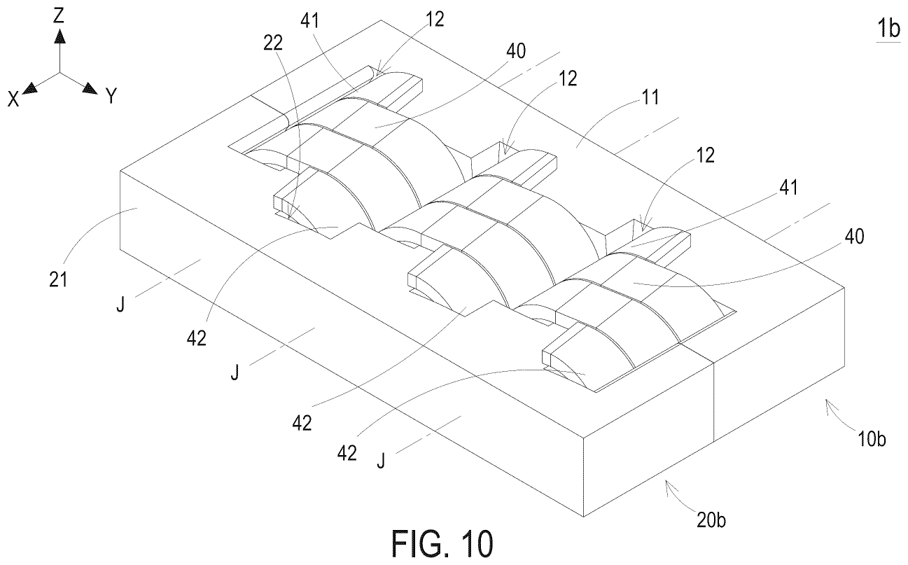

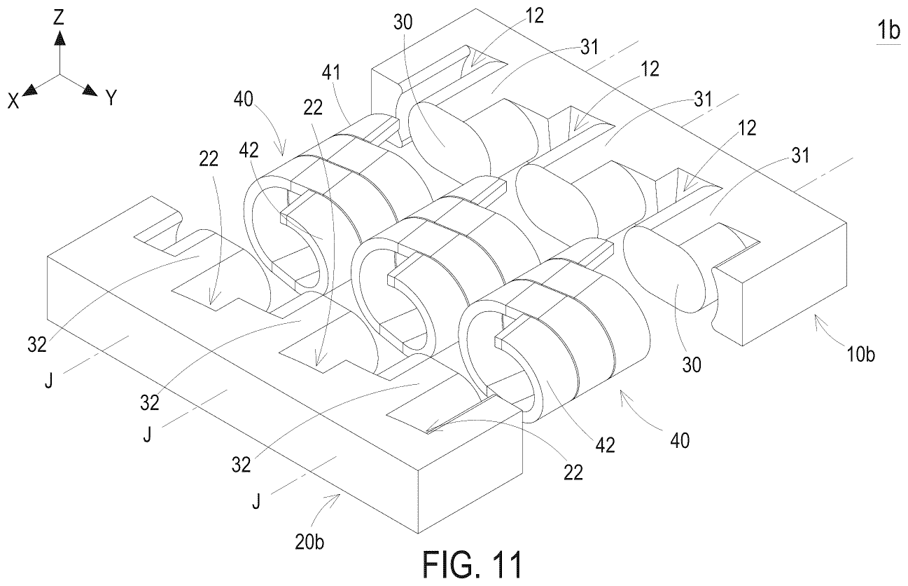

FIG. 10 is a structural perspective view illustrating a magnetic component according to a fifth embodiment of the present disclosure. FIG. 11 is an exploded structure view illustrating the magnetic component according to the fifth embodiment of the present disclosure. In the embodiment, the structures, elements and functions of the magnetic component 1b are similar to those of the magnetic component 1 of FIG. 1 to FIG. 3, and are not redundantly described herein. In the embodiment, the magnetic component 1b includes a first magnetic core 10b, a second magnetic core 20b and three coils 40. The first magnetic core 10b includes a first magnetic cover 11 and three first guiding portions 12. The second magnetic core 20b includes a second magnetic cover 21 and three second guiding portions 22. The first magnetic core 10b and the second magnetic core 20b are butted along the axial direction J to form three winding columns 30. The three winding columns 30 are arranged in parallel along a direction (such as the Y axial direction) perpendicular to the axial direction J. The three coils 40 are wound on the three winding columns 30, respectively. In some embodiments, the magnetic component 1b includes N first guiding portions 12, N second guiding portions 22, N winding columns 30 and N coils 40, and N is an integer and greater than or equal to 2. The N winding columns 30 are arranged in parallel or in a matrix along a direction (such as the Y axial direction) perpendicular to the axial direction J, and the N coils 40 are wound on the N winding columns 30, respectively. Thereby, the matching between the magnetic core and the coil 40 in the magnetic component 1b is improved, it allows expanding along the specific direction (i.e., the Y axial direction) perpendicular to the axial direction J, and realizing the efficient and automated assembly of the coil 40 and the magnetic core at the same time. Certainly, the number and the combination of the first guiding portions 12, the second guiding portions 22, the winding columns 30 and the coils 40 are adjustable according to the practical requirements. The present disclosure is not limited thereto.

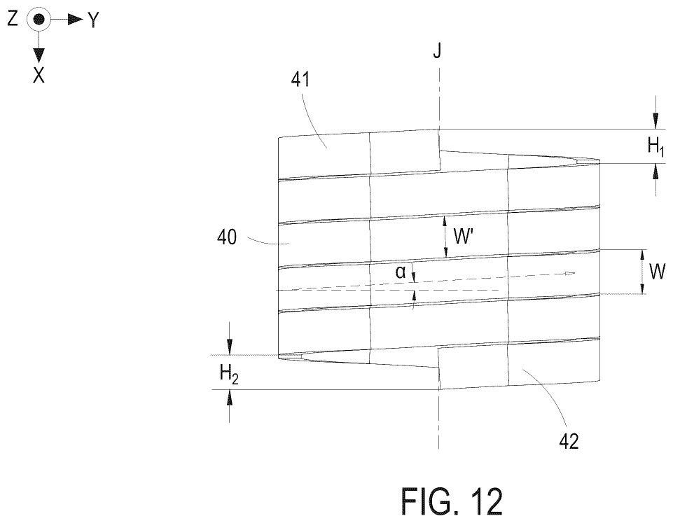

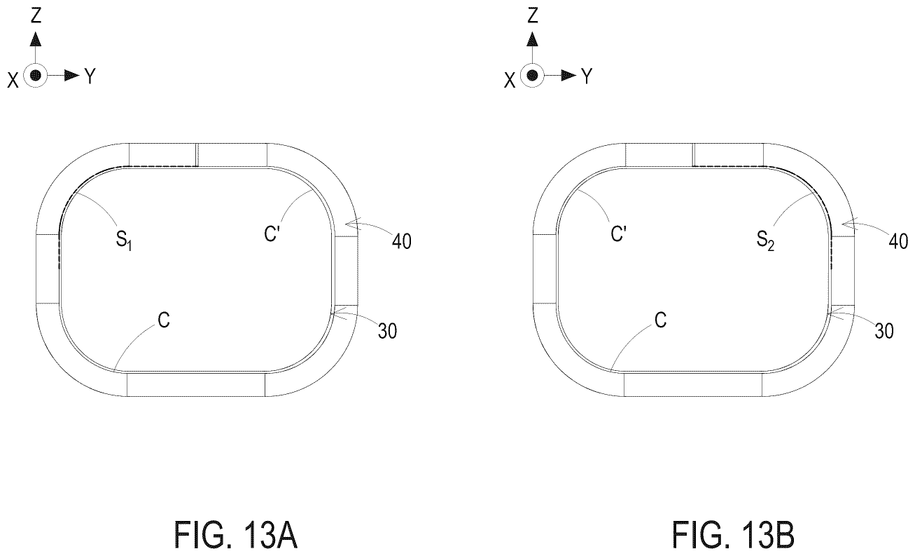

In addition, notably, in the above embodiments, the shapes of the winding column 30 and the coil 40 and the number of turns of the coil 40 wound on the winding column 30 are adjustable according to the practical requirements. FIG. 12 is a top view illustrating the flat wire coil flatly wound on the rounded rectangular winding column. FIG. 13A and FIG. 13B are schematic views illustrating the flat wire coil flatly wound on the rounded rectangular winding column in view of the axial direction. Please refer to FIG. 1 to FIG. 3, FIG. 12, FIG. 13A and FIG. 13B. In an embodiment, the coil 40 is wound around the winding column 30 M turns, M is an integer and is greater than or equal to 2. In the embodiment, the coil 40 is wound around the winding column 30 five turns. In the embodiment, the coil 40 travels in each turn to have an inner winding circumference C, which is greater than or equal to an outer circumference C′ of the winding column 30. Moreover, the coil 40 travels in each turn to add a winding width W along the axial direction J, and the coil 40 has a coil width W′ and is wound on the winding column 30 according to a winding coefficient A. In the embodiment, the winding width W satisfies: W=W′. A. In the embodiment, the winding coefficient A is ranged from 1 to 1.5. In some embodiments of the present disclosure, the winding coefficient A is ranged from 1.05 to 1.15. Moreover, the helical angle α satisfies:

$$α = {tan}^{- 1} \frac{W}{C} .$$

Moreover, in the embodiment, the coil 40 is received in the first guiding portion 12 to form a first inner diameter length S₁, and the coil 40 is received in the second guiding portion 22 to form a second inner diameter length S₂. In the embodiment, the first inner diameter length S₁ of the coil 40 is equal to the second inner diameter length S₂ of the coil 40. Furthermore, in the embodiment, the first extending width H₁ of the first outlet terminal 41 of the coil 40 satisfies:

$${H}_{1} = \frac{W \cdot {S}_{1}}{C} ,$$

and the second extending width H₂ of the second outlet terminal 42 of the coil 40 satisfies:

$${H}_{2} = \frac{W \cdot {S}_{2}}{C} .$$

In this way, the structures of the first magnetic core 10 and the second magnetic core 20 are further improved through the first guiding portion 12 and the second guiding portion 22, respectively, and it allows the coil 40 saving a size H=H₁+H₂ in the axial direction J. In an embodiment, the first extending width H₁ of the first outlet terminal 41 is equal to the second extending width H₂ of the second outlet terminal 42. Certainly, in other embodiments, the first extending width H₁ of the first outlet terminal 41 and the second extending width H₂ of the second outlet terminal 42 can be designed in different sizes, and the present disclosure is not limited thereto.

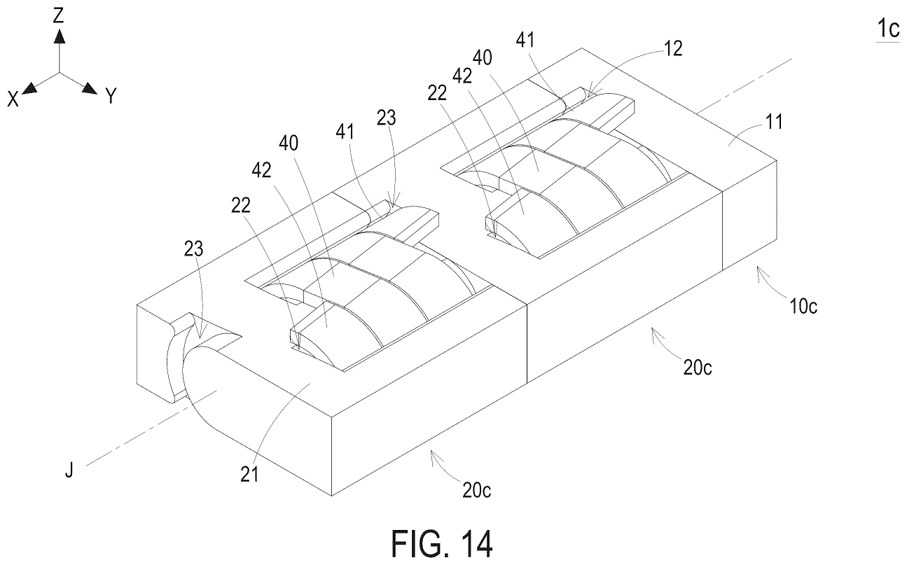

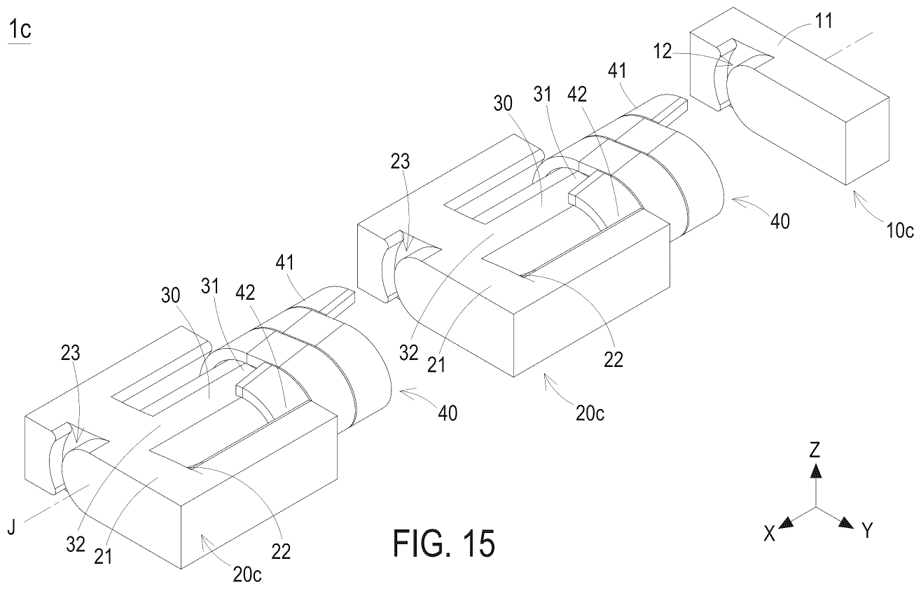

FIG. 14 is a structural perspective view illustrating a magnetic component according to a sixth embodiment of the present disclosure. FIG. 15 is an exploded structural view illustrating the magnetic component according to the sixth embodiment of the present disclosure. In the embodiment, the structures, elements and functions of the magnetic component 1c are similar to those of the magnetic component 1 of FIG. 1 to FIG. 3, and are not redundantly described herein. In the embodiment, the magnetic component 1c includes one first magnetic core 10c, two second magnetic cores 20c and two coils 40. The first magnetic core 10c is an I-shaped magnetic core, and the winding column 30 is disposed on a side of the second magnetic cover 21 close to the first magnetic cover 11. In the embodiment, the second magnetic core 20c further includes a third guiding portion 23, which is disposed on a side of the second magnetic cover 21 away from the first magnetic cover 11 and spatially corresponding to first guiding portion 12 along the axial direction J. In some embodiments, the third guiding portion 23 and the first guiding portion 12 have the same structure. During assembly, the first magnetic core 10c and the second magnetic core 20c are butted along the axial direction J to form a winding column 30. The two second magnetic cores 20c are connected in series along the axial direction J. When the coil 40 is wound around the winding column 30 between the first magnetic core 10c and the second magnetic core 20c, the first outlet terminal 41 is led out along the first guiding portion 12, and the second outlet terminal 42 is led out along the second guiding portion 22. In addition, the two second magnetic cores 20c are connected in series along the axial direction J to form another winding column 30. When the coil 40 is wound around the winding column 30 between the two second magnetic cores 20c, the first outlet terminal 41 is led out along the third guiding portion 23, and the second outlet terminal 42 is led out along the second guiding portion 22. In this way, the matching between the magnetic core and the coil 40 in the magnetic component 1c is improved, it allows expanding along the axial direction J (i.e., the negative direction of the X axis), and realizing the efficient and automated assembly of the coil 40 and the magnetic core at the same time.

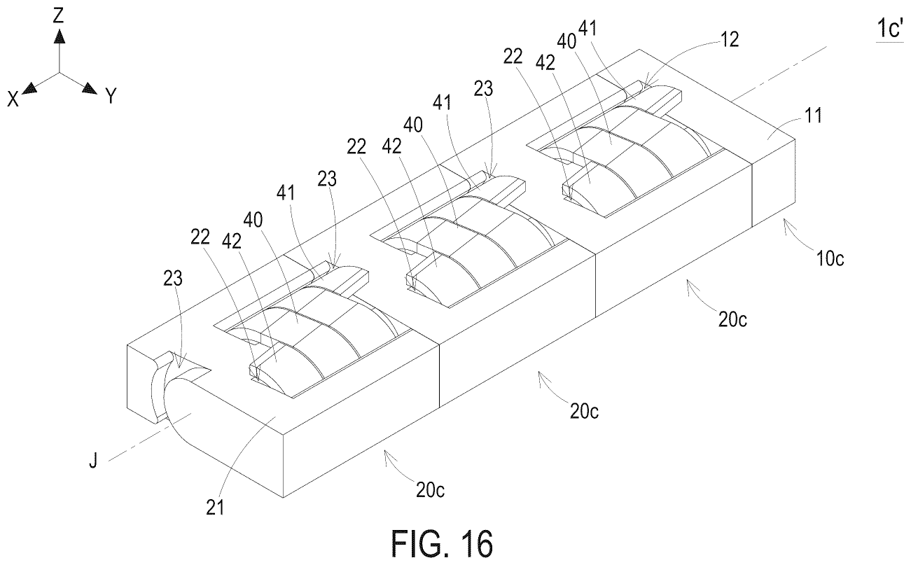

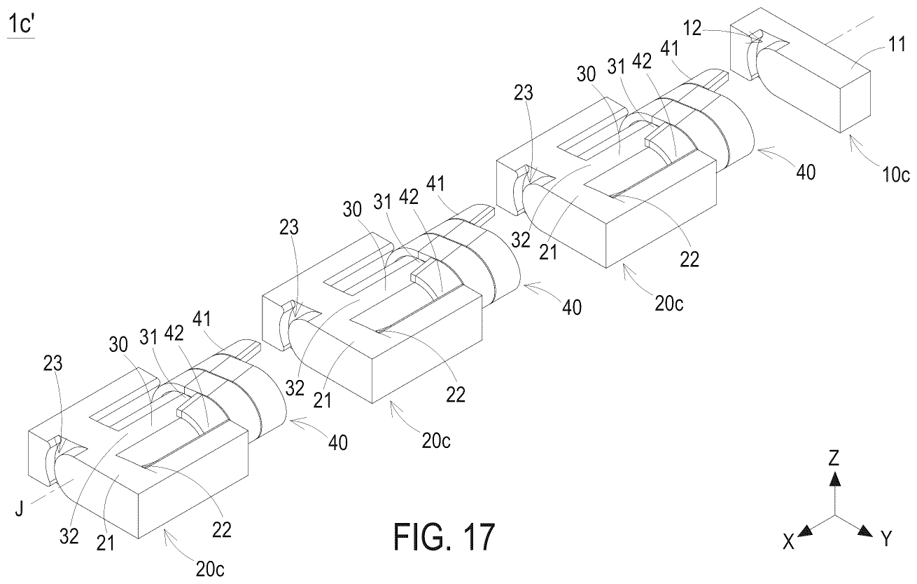

FIG. 16 is a structural perspective view illustrating a magnetic component according to a seventh embodiment of the present disclosure. FIG. 17 is an exploded structural view illustrating the magnetic component according to the seventh embodiment of the present disclosure. In the embodiment, the structures, elements and functions of the magnetic component 1c′ are similar to those of the magnetic component 1c of FIG. 14 to FIG. 15, and are not redundantly described herein. In the embodiment, the magnetic component 1c′ includes one first magnetic core 10c, three second magnetic cores 20c and three coils 40. The first magnetic core 10c is an I-shaped magnetic core, and the winding column 30 is disposed on a side of the second magnetic cover 21 close to the first magnetic cover 11. In the embodiment, the second magnetic core 20c further includes a third guiding portion 23, which is disposed on a side of the second magnetic cover 21 away from the first magnetic cover 11 and spatially corresponding to first guiding portion 12 along the axial direction J. In some embodiments, the third guiding portion 23 and the first guiding portion 12 have the same structure. During assembly, the first magnetic core 10c and the second magnetic core 20c are butted along the axial direction J to form a winding column 30. The three second magnetic cores 20c are connected in series along the axial direction J. When the coil 40 is wound around the winding column 30 between the first magnetic core 10c and the second magnetic core 20c, the first outlet terminal 41 is led out along the first guiding portion 12, and the second outlet terminal 42 is led out along the second guiding portion 22. In addition, the two of the second magnetic cores 20c are connected in series along the axial direction J to form the other winding column 30. When the coil 40 is wound around the winding column 30 between the two second magnetic cores 20c, the first outlet terminal 41 is led out along the third guiding portion 23, and the second outlet terminal 42 is led out along the second guiding portion 22. In other embodiments, the magnetic component 1c′ includes one first magnetic core 10c, N second magnetic cores 20c, N second guiding portions 22, N third guiding portions 23, N winding columns 30 and N coils 40. N is an integer and greater than or equal to 2. The N second magnetic cores 20c are connected in series along the axial direction J. The N winding columns 30 are arranged in parallel along the axial direction J, and the N coils 40 are wound around the N winding columns 30, respectively. In this way, the matching between the magnetic core and the coil 40 in the magnetic component 1c′ is improved, it allows expanding along the axial direction J (i.e., the negative direction of the X axis), and realizing the efficient and automated assembly of the coil 40 and the magnetic core at the same time. Certainly, the present disclosure is not limited thereto. In some embodiments of the present disclosure, the Nth second magnetic core 20c is provided with only one second guiding portion 22 without providing the third guiding portion 23. That is, the magnetic component 1c′ includes one first magnetic core 10c, N second magnetic cores 20c, N second guiding portions 22, N−1 third guiding portions 23, N winding columns 30 and N coils 40. N is an integer and greater than or equal to 2. The N second magnetic cores 20c are connected in series along the axial direction J. The N winding columns 30 are arranged in parallel along the axial direction J, and the N coils 40 are wound around the N winding columns 30, respectively.

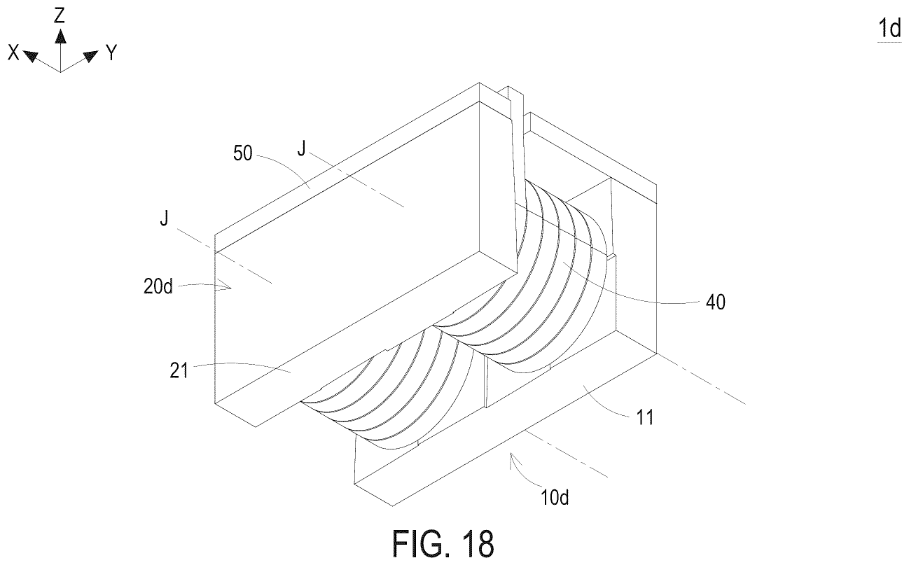

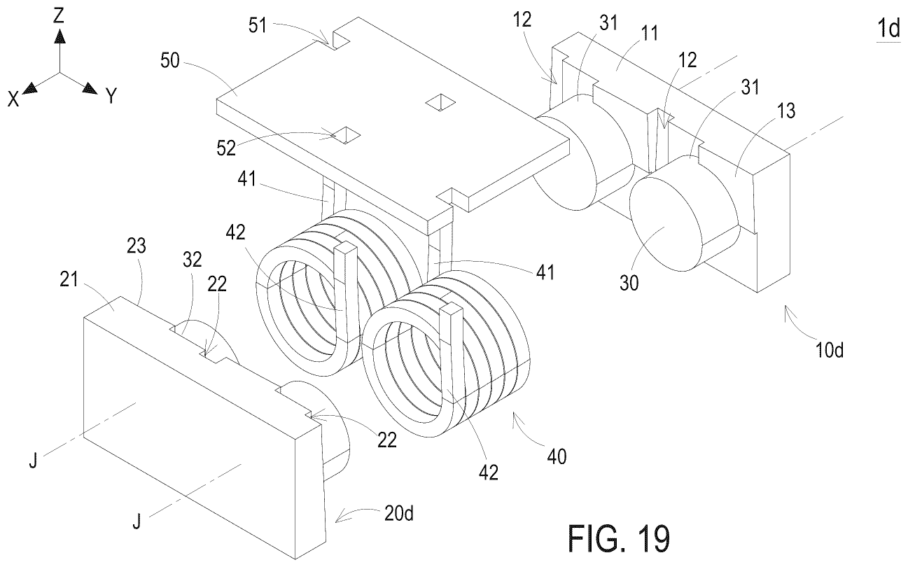

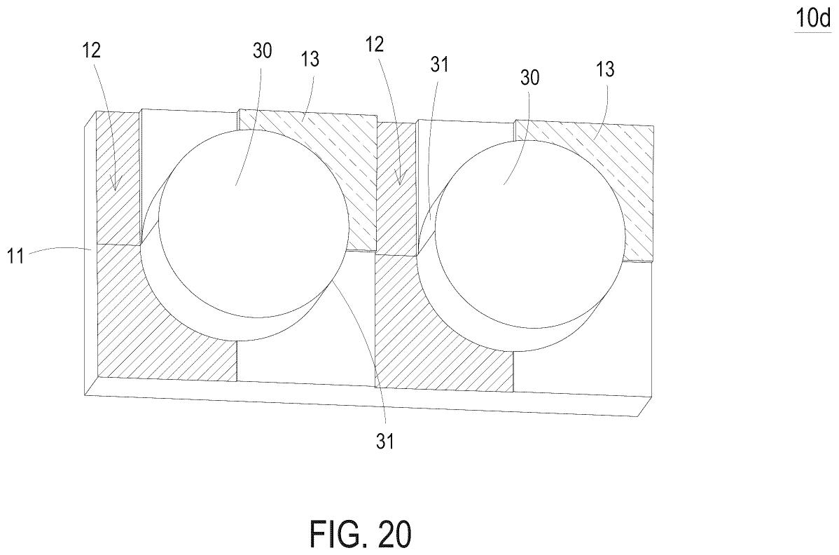

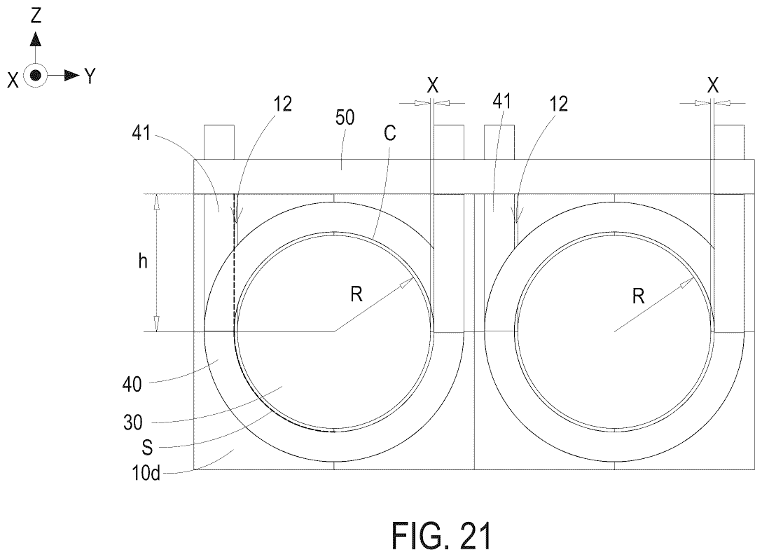

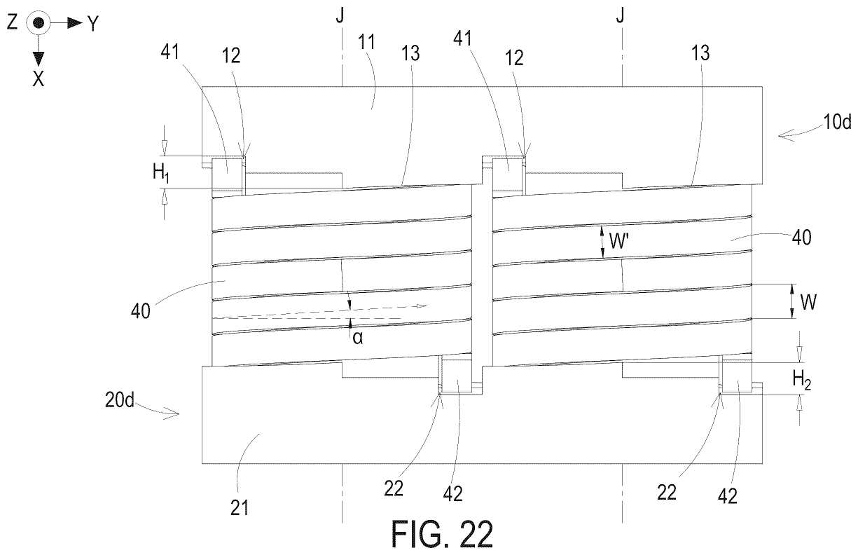

FIG. 18 is a structural perspective view illustrating a magnetic component according to an eighth embodiment of the present disclosure. FIG. 19 is an exploded structural view illustrating the magnetic component according to the eighth embodiment of the present disclosure. FIG. 20 is a structural perspective view illustrating the first magnetic core of the magnetic component according to the eighth embodiment of the present disclosure. FIG. 21 is a schematic diagram illustrating the coil wound on the magnetic core of the magnetic component according to the eighth embodiment of the present disclosure in view of the axial direction. FIG. 22 is a schematic diagram illustrating the coil wound on the magnetic core of the magnetic component according to the eighth embodiment of the present disclosure from the top perspective. In the embodiment, the structures, elements and functions of the magnetic component Id are similar to those of the magnetic component 1 of FIG. 1 to FIG. 3, and are not redundantly described herein. In the embodiment, the magnetic component 1d includes a first magnetic core 10d, a second magnetic core 20d, two coils 40 and a base 50. The first magnetic core 10d includes a first magnetic cover 11 and two first guiding portions 12. The second magnetic core 20d includes a second magnetic cover 21 and two second guiding portions 22. In some embodiments, the first magnetic core 10d and the second magnetic core 20d have the same structure. In the embodiment, the first magnetic core 10d and the second magnetic core 20d are butted along the axial direction J to form two round winding columns 30. In the embodiment, the winding column 30 has a first end 31 and a second end 32 oppositely arranged along the axial direction J. The first magnetic cover 11 is located at the first end 31, and the second magnetic cover 21 is located at the second end 32. The first guiding portion 12 is disposed adjacent to the first end 31 and located on the first magnetic cover 11, and increases a depth embedded into the first magnetic cover 11 along a direction (i.e., the negative direction of the X axis) from the second magnetic cover 21 facing the first magnetic cover 11. In addition, the second guiding portion 22 is disposed adjacent to the second end 32 and located on the second magnetic cover 21, and increases a depth embedded into the second magnetic cover 21 along a direction (i.e., the positive direction of the X axis) from the first magnetic cover 11 facing the second magnetic cover 21. Each coil 40 is wound on the corresponding winding column 30 at a helical angle α relative to the winding column 30, and includes a first outlet terminal 41 and a second outlet terminal 42. In the embodiment, the first outlet terminal 41 is led out along the first guiding portion 12, and the second outlet terminal 42 is led out along the second guiding portion 22.

In the embodiment, along a direction (i.e., the positive direction of the Z axis) parallel to the lateral sides of the first magnetic cover 11 and the second magnetic cover 21, the first outlet terminal 41 and the second outlet terminal 42 are led out from the first guiding portion 12 and the second guiding portion 22, respectively, and connected to the first through hole 51 and the second through hole 52 of a base 50, so as to form two inductors.

In an embodiment, the first magnetic core 10d further includes a first protruding platform 13. The first protruding platform 13 is disposed adjacent to the first end 31 and located on the first magnetic cover 11, and protrudes from the first magnetic cover 11 toward the second magnetic cover 21. In some embodiments, the first protruding platform 13 is disposed and corresponds to at least one part of the second guiding portion 22 along the axial direction J. Similarly, the second magnetic core 20d further includes a second protruding platform 23. The second protruding platform 23 is disposed adjacent to the second end 32 and located on the second magnetic cover 21, and protrudes from the second magnetic cover 21 toward the first magnetic cover 11. In some embodiments, the second protruding platform 23 is disposed and corresponds to at least one part of the first guiding portion 12 along the axial direction J.

In the embodiment, the coil 40 and the winding column 30 have a matching gap X. The coil 40 has a coil width W′ and is wound on the winding column 30 at a helical angle α according to a winding coefficient A. The winding width W satisfies: W=W′·A. The two winding columns 30 have the same radius R. The coil 40 has an inner winding circumference C=2π(R+X). There is a height h from the center of the winding column 30 to the bottom surface of the magnetic core on the outlet side (i.e., the surface of the base 50). The coil 40 travels along the spiral groove of the first guiding portion 12 and has an inner diameter length s=π(R+X)/2+h. In that, the first extending width H₁ of the first outlet terminal 41 that can be saved satisfies:

$${H}_{1} = \frac{W \cdot S}{C} .$$

Moreover, the second extending width H₂ of the second outlet terminal 42 is also the same, and not redundantly described herein.

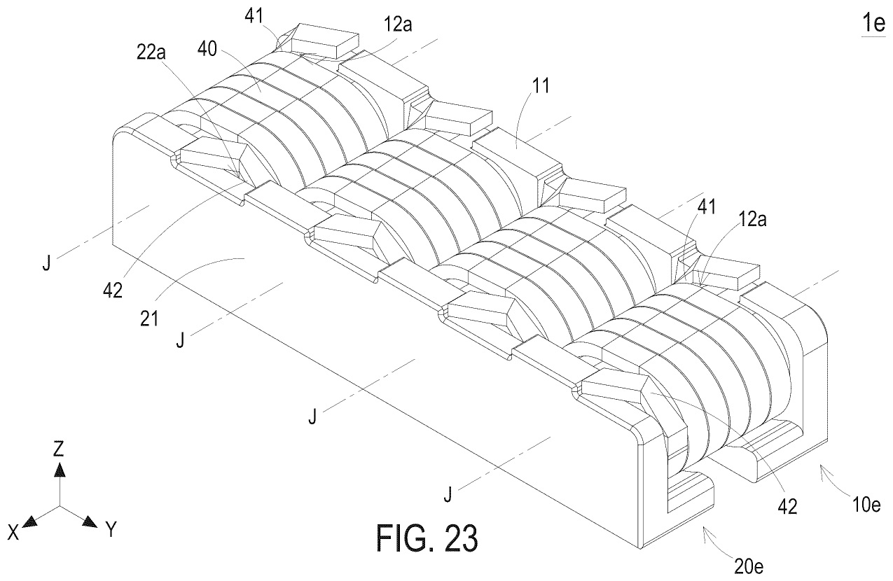

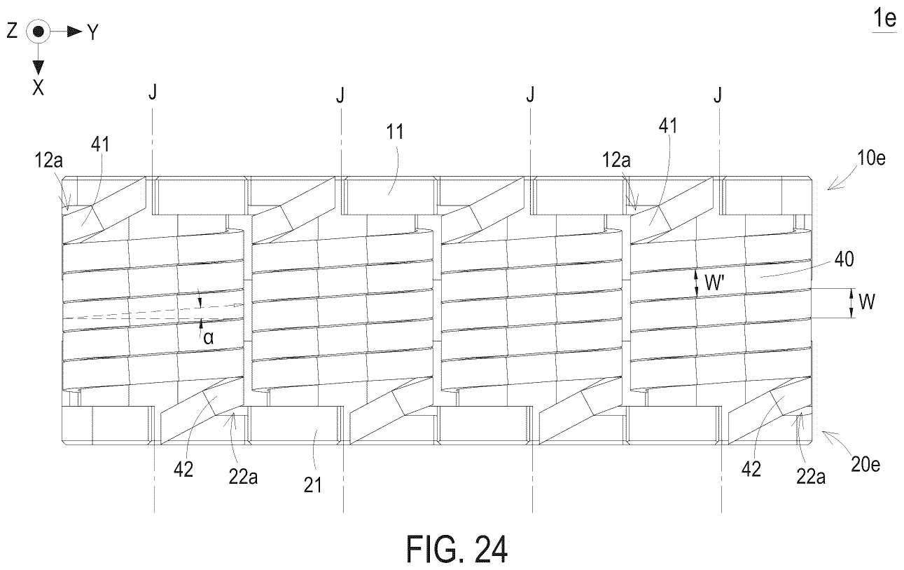

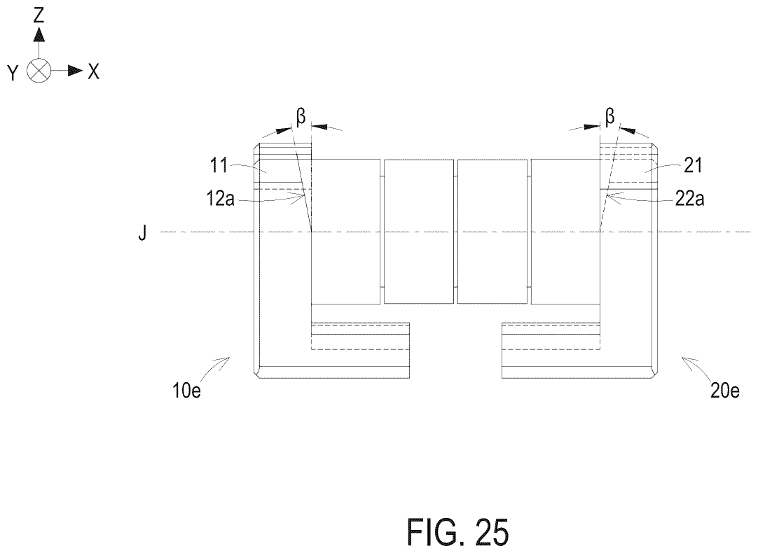

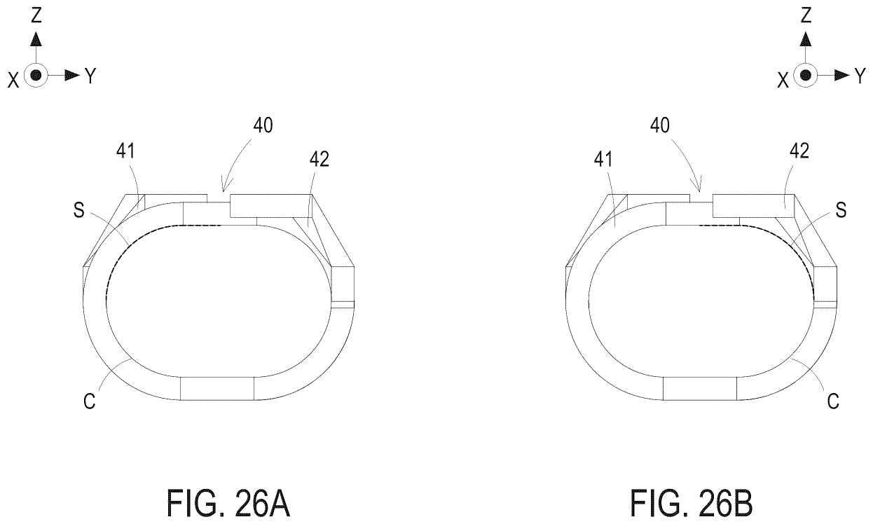

FIG. 23 is a structural perspective view illustrating a magnetic component according to a ninth embodiment of the present disclosure. FIG. 24 is a schematic diagram of illustrating the coil wound on the magnetic core of the magnetic component according to the ninth embodiment of the present disclosure from the top perspective. FIG. 25 is a structural lateral view illustrating the first magnetic core and the second magnetic core of the magnetic component according to the ninth embodiment of the present disclosure. FIG. 26A and FIG. 26B are schematic views illustrating the coil of the magnetic component according to the ninth embodiment of the present disclosure in view of the axial direction. In the embodiment, the structures, elements and functions of the magnetic component 1e are similar to those of the magnetic component 1 of FIG. 1 to FIG. 3, and are not redundantly described herein. In the embodiment, the magnetic component 1e includes a first magnetic core 10e, a second magnetic core 20e and four coils 40. The first magnetic core 10e and the second magnetic core 20e are butted along the axial direction J parallel to the X axis to form four winding columns 30. The four coils 40 are wound on the corresponding winding columns 30 at a helical angle α relative to the four winding columns 30, and each coil 40 includes a first outlet terminal 41 and a second outlet terminal 42. In the embodiment, the first outlet terminal 41 and the second outlet terminal 42 are led out from the first guiding portion 12a and the second guiding portion 22a, respectively along a direction parallel to the lateral sides of the first magnetic cover 11 and the second magnetic cover 21, that is, the Y axial direction. In some embodiments, the first outlet terminal 41 is welded to a solder pad (not shown) on the top edge of the first magnetic cover 11, and the second outlet terminal 42 is welded to a solder pad (not shown) on the top edge of the second magnetic cover 21, so that the magnetic component 1e forms a low-voltage and high-current coupled inductor. In the embodiment, the number of turns of the coil 40 wound flatly around the winding column 30 is 6 turns. The coil has a coil width W′ and is wound on the winding column according to a winding coefficient A, wherein the winding width W satisfies: W=W′·A. In the embodiment, the winding coefficient A is ranged from 1 to 1.5. In some embodiments of the present disclosure, the winding coefficient A is ranged from 1.05 to 1.15. In the embodiment, the coil 40 travels in each turn to have an inner winding circumference C. The helical angle α satisfies:

$$α = {tan}^{- 1} \frac{W}{C} .$$

The first guiding portion 12a and the second guiding portion 22a have an inclination angle β greater than the helical angle α of the first outlet terminal 41 and the second outlet terminal 42. In addition, the coil 40 is received in the first guiding portion 12a to form a first inner diameter length S, and the coil 40 is received in the second guiding portion 22a to form a second inner diameter length S. Thereby, the arrangement of the first guiding portion 12a and the second guiding portion 22a is utilized to save the dimension

$$H = \frac{2 \cdot W \cdot S}{C} .$$

In the embodiment, the backs of the first magnetic core 10e and the second magnetic core 20e have a maximum magnetic density limitation. If the assembling tolerance of the coil 40 and the first magnetic core 10e and the second magnetic core 20e is considered, the number of turns of the coil 40 will be limited within the magnetic core window formed by the first magnetic core 10e and the second magnetic core 20e. The magnetic component 1e is allowed to increase the number of turns of the coil 40 wound flatly around the winding column 30 from 5 turns to 6 turns through the arrangement of the first guiding portion 12a and the second guiding portion 22a. Thereby, the saturation current of the four series connections is increased. Certainly, the size and the type of the first guiding portion 12a and the second guiding portion 22a, the number of coils 40 and the number of flat-wound turns are adjustable according to the practical requirements, and the present disclosure is not limited thereto.

In summary, the present disclosure provides a magnetic component with an improved structure. The magnetic core has an improved structure (such as a spiral groove, a slope-shaped groove or a stepped groove) at the coil outlet position, so as to ensure that the outlet position does not affect the configuration of the magnetic core, and further realize that the height of the magnetic core does not need to be designed according to the maximum coil size. When the magnetic component has the overload requirements, the number of coil turns can be appropriately increased to enhance the anti-saturation capability of the magnetic component and at the same time increase the power density of the magnetic component. Since the groove structure and the shape of the coil are basically matched with each other, the coil is not prone to skewing during assembly. It also helps to meet the automated production requirements, improve the quality and reduce the costs. By processing the inner wall of the magnetic core into a structure of a spiral groove, a slope-shaped groove or a stepped groove, the height of the magnetic core window occupied by the coil outlet is reduced and the utilization rate of the magnetic core window is improved, so that the purposes of increasing the number of coil turns, increasing the cross-sectional area of the wires or reducing the height and the size of the winding column are achieved. It also improves the matching between the magnetic core and the coil, and helps to realize the efficient and automated assembly of the coil and the magnetic core.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic component, comprising:
a first magnetic core, comprising a first magnetic cover and a first guiding portion;
a second magnetic core, comprising a second magnetic cover and a second guiding portion, wherein the first magnetic core and the second magnetic core are butted along an axial direction to form a winding column, wherein the winding column has a first end and a second end oppositely arranged along the axial direction, the first magnetic cover is located at the first end, and the second magnetic cover is located at the second end, wherein the first guiding portion is disposed adjacent to the first end and located on the first magnetic cover, and increases a depth embedded into the first magnetic cover along a direction from the second magnetic cover facing the first magnetic cover, wherein the second guiding portion is disposed adjacent to the second end and located on the second magnetic cover, and increases a depth embedded into the second magnetic cover along a direction from the first magnetic cover facing the second magnetic cover; and
a coil, wound on the winding column at a helical angle α relative to the winding column, and comprising a first outlet terminal and a second outlet terminal, wherein the first outlet terminal is led out along the first guiding portion, and the second outlet terminal is led out along the second guiding portion.

2. The magnetic component according to claim 1, wherein the coil is wound around the winding column M turns, M is an integer and is greater than or equal to 2, wherein the coil travels in each turn to have an inner winding circumference C, which is greater than or equal to an outer circumference C′ of the winding column, wherein the coil travels in each turn to add a winding width W along the axial direction, and the coil has a coil width W′ and is wound on the winding column according to a winding coefficient A, wherein the winding width W satisfies: W=W′·A.

3. The magnetic component according to claim 2, wherein the coil is received in the first guiding portion to form a first inner diameter length S₁, and the coil is received in the second guiding portion to form a second inner diameter length S₂.

4. The magnetic component according to claim 3, wherein the first inner diameter length S₁ of the coil is equal to the second inner diameter length S₂ of the coil.

5. The magnetic component according to claim 3, wherein the first guiding portion and the second guiding portion are spiral grooves, and shapes of the first guiding portion and the second guiding portion are matched with shapes of the first outlet terminal and the second outlet terminal, respectively.

6. The magnetic component according to claim 3, wherein the first guiding portion forms a first slope-shaped groove along the first outlet terminal toward a side away from the first outlet terminal, and the second guiding portion forms a second slope-shaped groove along the second outlet terminal toward a side away from the second outlet terminal, wherein the first guiding portion and the second guiding portion have an inclination angle β greater than the helical angle α of the first outlet terminal and the second outlet terminal, a first depth D₁ of the first slope-shaped groove along the axial direction is greater than a first extending width H₁ of the first outlet terminal, and a second depth D₂ of the second slope-shaped groove along the axial direction is greater than a second extending width H₂ of the second outlet terminal.

7. The magnetic component according to claim 6, wherein the first extending width H₁ of the first outlet terminal satisfies:
$${H}_{1} = \frac{W \cdot {S}_{1}}{C} ,$$
and the second extending width H₂ of the second outlet terminal satisfies:
$${H}_{2} = \frac{W \cdot {S}_{2}}{C} .$$

8. The magnetic component according to claim 3, wherein the first guiding portion forms a first stepped groove along the first outlet terminal toward a side away from the first outlet terminal, and the second guiding portion forms a second stepped groove along the second outlet terminal toward a side away from the second outlet terminal, wherein a first depth D₁ of the first stepped groove along the axial direction is greater than a first extending width H₁ of the first outlet terminal, and a second depth D₂ of the second stepped groove along the axial direction is greater than a second extending width H₂ of the second outlet terminal.

9. The magnetic component according to claim 8, wherein the first extending width H₁ of the first outlet terminal satisfies:
$${H}_{1} = \frac{W \cdot {S}_{1}}{C} ,$$
and the second extending width H₂ of the second outlet terminal satisfies:
$${H}_{2} = \frac{W \cdot {S}_{2}}{C} .$$

10. The magnetic component according to claim 2, wherein the winding coefficient A is ranged from 1 to 1.5.

11. The magnetic component according to claim 10, wherein the winding coefficient A is ranged from 1.05 to 1.15.

12. The magnetic component according to claim 2, wherein the helical angle α satisfies:
$$α = {tan}^{- 1} \frac{W}{C} .$$

13. The magnetic component according to claim 2, wherein the coil and the winding column have a matching gap X.

14. The magnetic component according to claim 2, wherein the first outlet terminal and the second outlet terminal are led out from the first guiding portion and the second guiding portion in a direction parallel to lateral sides of the first magnetic cover and the second magnetic cover, respectively.

15. The magnetic component according to claim 1, wherein the first magnetic core is an I-shaped magnetic core, and the winding column is disposed on a side of the second magnetic cover close to the first magnetic cover.

16. The magnetic component according to claim 15, wherein the second magnetic core further comprises a third guiding portion, which is disposed on a side of the second magnetic cover away from the first magnetic cover and spatially corresponding to first guiding portion along the axial direction, wherein the third guiding portion and the first guiding portion have the same structure.

17. The magnetic component according to claim 16, wherein the magnetic component includes one first magnetic core, N second magnetic cores, N second guiding portions, N third guiding portions, N winding columns and N coils, and N is an integer and greater than or equal to 2, wherein the N second magnetic cores are connected in series along the axial direction, the N winding columns are arranged in parallel along the axial direction, and the N coils are wound around the N winding columns, respectively.

18. The magnetic component according to claim 1, wherein the magnetic component includes N first guiding portions, N second guiding portions, N winding columns and N coils, and N is an integer and greater than or equal to 2, wherein the N winding columns are arranged in parallel or in a matrix along a direction perpendicular to the axial direction, and the N coils are wound on the N winding columns, respectively.

19. The magnetic component according to claim 1, wherein the first magnetic core further comprises a first protruding platform, which is disposed adjacent to the first end and located on the first magnetic cover, and protrudes from the first magnetic cover toward the second magnetic cover, wherein the first protruding platform is disposed and corresponds to at least one part of the second guiding portion along the axial direction, wherein the second magnetic core further comprises a second protruding platform, which is disposed adjacent to the second end and located on the second magnetic cover, and protrudes from the second magnetic cover toward the first magnetic cover, wherein the second protruding platform is disposed and corresponds to at least one part of the first guiding portion along the axial direction.

20. The magnetic component according to claim 1, wherein the first guiding portion increases by a first depth D₁ along the direction from the second magnetic cover facing the first magnetic cover, and the second guiding portion increases by a second depth D₂ along the direction from the first magnetic cover facing the second magnetic cover, wherein the first depth D₁ and the second depth D₂ are equal to each other.

21. The magnetic component according to claim 1, wherein a cross section of the winding column perpendicular to the axial direction is circular, racetrack-shaped or rounded rectangular.

22. The magnetic component according to claim 1, wherein the magnetic component is suitable for a low-voltage and high-current conventional inductors, a matrix inductor, a coupled inductor, a conventional transformer or a matrix transformer.

23. The magnetic component according to claim 1, wherein the coil comprises a round wire or a flat wire.
